(19) United States
(12) Patent Application Publication
(10) Pub. No.: US 2003/0050884 A1
(43) Pub. Date: Mar. 13, 2003

(54) Securitizing financial assets

(76) Inventor: Gary Barnett, New York, NY (US)

Correspondence Address: Shearman & Sterling, Intellectual Property Docketing, 599 Lexington Avenue, New York, NY, 10022, US

(21) Appl. No.: 10/239,773

(22) PCT Filed: Mar. 23, 2001
(86) PCT No.: PCT/US01/09393

(51) Int. Cl. G06F 17/60

(52) U.S. Cl. 705/35

(57) ABSTRACT

A business method is chartered by a defined group of competing independent buyer/obligor companies (102), to acquire or finance receivables (106) of the buyer/obligor companies (102). In cooperative consultation between the buyer/obligor companies (102) and the business entity (100), terms of receivables (106) of the buyer/obligor companies (102) are defined, to improve efficiency of financing the receivables. The buyer/obligor companies (102) agree to preferentially disclose credit information on themselves to the business entity (100). Obligee companies (104) agree to accept book entries on a computer system operated by the business entity (100) as the controlling form of financial obligations arising out of sale of goods or services (108) sold by to buyer/obligor companies. The business entity accepts custody of a majority of a class of receivables of buyer/obligor companies to creditor companies. The receivables (106) are recorded on a computer system that also functions as a business-to-business platform for the sales of the goods. The business entity extends offers to holders of the receivables for purchase of the receivables. The business entity sells to the capital markets securities (114) backed by cash flows from receivables purchased pursuant to the offers. A market for trading of the receivables is provided through computer access to inventory information and order placement facilities.

This application claims priority from U.S. provisional application serial No. 60/191,901, filed Mar. 24, 2000, which is incorporated herein by reference.

### BACKGROUND

The invention relates to arrangements for financial or business practices.

The rise of the internet has accelerated the emergence of business-to-business (or “B2B”) markets, for instance, those in which business transactions may be negotiated and agreed electronically. Computers and their operations provide a significant part of the infrastructure of a B2B marketplace, and facilitate business transactions in those markets with efficiencies previously unforeseen.

In recent years, companies have obtained financing by engaging in “securitization” transactions in which the company (or, more typically, a bankruptcy-remote special purpose vehicle) issues debt instruments backed by an asset or pool of assets in which the principal and interest is paid from the cash flow generated by the assets. In most securitizations, the transaction is structured to exclude the credit risk of the sponsor of the transaction so that the credit worthiness of the debt instruments issued in the securitization depends primarily on the credit risk inherent in the underlying financial assets. Once the extent of such credit risk has been quantified, typically by a rating agency, a form of credit and liquidity support can be supplied to cover the risk, permitting the securities issued in the transaction to be highly rated, even in cases where the sponsor of the transaction is not rated or is a poor credit risk. The levels of credit support and liquidity required in a securitization may be a function of the requirements set by the rating agencies based on their analysis of the quality of the underlying assets and the structure of the securities in light of the probable rates of default and recovery on the underlying assets. Because traditional general obligation debt is backed by the credit of the entire operating company, and the operating company is subject to a wide range of risks in the market place, an operating company seeking to issue highly-rated general obligations may be required to maintain relatively higher levels of capital and liquidity than in a securitization transaction in which the risk can be segregated to the performance of particular assets.

Securitization transactions include “cash flow” or “market value” transactions. In a “cash flow” securitization, the securities issued in the transaction are paid from roughly matching payments expected to be received on the underlying assets. In “market value” securitizations, the ability to repay the securities depends on the sufficiency of, and ability to realize upon, the value of the underlying assets. For example, in a typical “market value” transaction, the initial offering raises enough cash to pay coupon payments, and the final terminating payment is financed by selling the assets to third parties.

### SUMMARY

In general, in a first aspect, the invention features an arrangement in which a business entity is chartered to acquire or finance debt of members of a defined group of competing independent businesses. In cooperative consultation between the independent businesses and the business entity, terms of debt instruments of the independent businesses to creditors are defined, the definition of terms being directed to improving efficiency of financing the debt.

In general, in a second aspect, the invention features an arrangement in which offers are extended from a business entity to holders of financial obligations of obligor companies for purchase of the obligations. The business entity is under cooperative operation of several independent companies. Securities backed by cash flows from obligations purchased pursuant to the offers are sold to the capital markets.

In general, in a third aspect, the invention features an arrangement in which offers are extended to purchase financial obligations of members of a defined group of competing obligor businesses. The obligations are receivables owed to obligees by the obligor businesses for purchase from the obligees of inputs to the obligor businesses. Securities backed by cash flows from obligations purchased pursuant to the offers are sold to the capital markets.

In general, in a fourth aspect, the invention features an arrangement in which goods and/or services are sold from a plurality of seller companies to a plurality of buyer companies. The buyer companies owe receivables to the seller companies for the goods. The receivables are recorded on a computer system that also functions as a business-to-business platform for the sales of the goods.

In general, in a fifth aspect, the invention features an arrangement in which a business entity extends offers to holders of financial obligations of obligor companies for purchase of the obligations. The business entity is under cooperative operation of several independent companies. The obligor companies agree to preferentially disclose credit information on themselves to the entity.

In general, in a sixth aspect, the invention features an arrangement in which obligor companies owe financial obligations to obligee companies for goods or services sold by obligee companies to obligor companies. The obligee companies agree to accept, as the controlling statement of the obligations, a book entry on a computer system operated by a business entity. The entity is chartered by at least some of said obligee or obligor companies as custodian for the obligations.

In general, in a seventh aspect, the invention features an arrangement in which a business entity accepts custody of a majority of a class of obligations of obligor companies to creditor companies. The business entity also serves as the recorder of the current ownership of the obligations. The business entity operates a market for trading of the obligations by providing computer access to inventory information and order placement facilities.

Embodiments of the invention may include one or more of the following features. The business entity may finance the receivables by offering aggregated baskets of debt of two or more of the independent businesses on the capital markets. The defined terms may include waiver by the independent businesses of defenses to payment or collection of the debt. The defined terms may include the addition of representations and warranties to the debt. The defined terms may include standardizing terms of debt instruments of all members of the group of independent businesses. A plurality of purchased debts may be aggregated for offer of a securitization to a secondary market. At least two baskets of the obligations may be simultaneously aggregated for securitization to the capital markets as two separate securities. In cooperative consultation between the obligor companies, the business entity, and a commercial rating agency, terms of debt instruments of the obligor companies may be defined, directed to improving efficiency of financing the debt.

These attributes, advantages and features are of representative embodiments only. Additional features and advantages of the invention will become apparent in the following description, from the drawings, and from the claims.

### DESCRIPTION OF TIHE DRAWING

FIG. 1 is a block diagram of parties and cash flows in a transaction.

### DESCRIPTION

### I. Overview

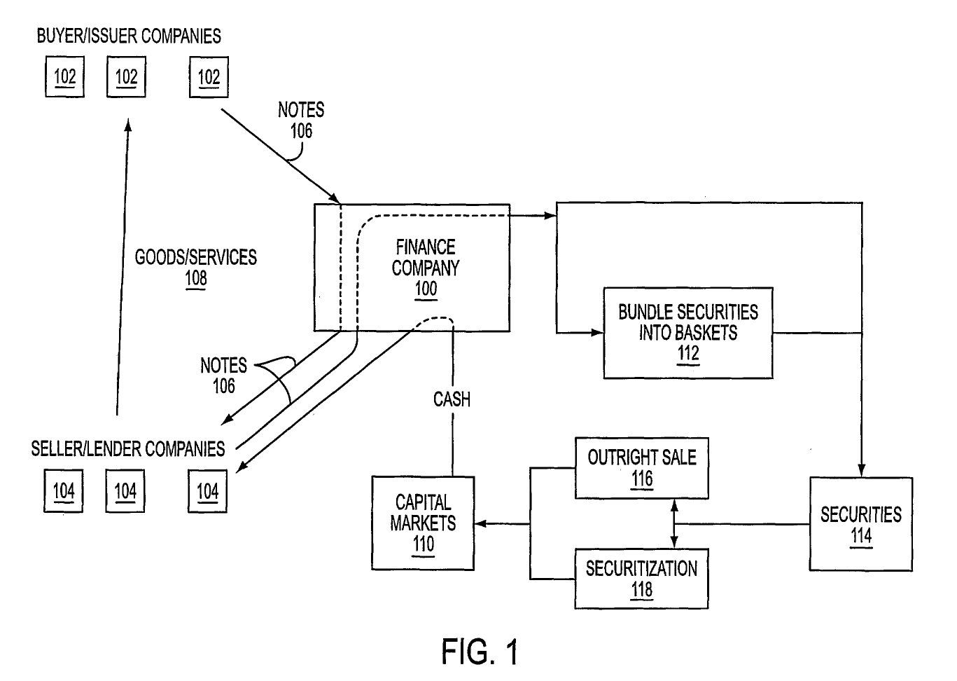

Referring to FIG. 1, companies 102 are buyers, and companies 104 are sellers of goods and/or services 108, possibly in an internet-intermediated B2B marketplace. The purchases by buyer companies 102 create receivables, notes or other rights to payment 106, that are owned by the seller companies 104. In some cases, a seller 104 may need immediate cash, rather than the deferred payment due on receivable or note 106, and thus may need to finance notes 106. A specialized finance company 100 may provide access to the capital markets through securitization, or may obtain more traditional lending (for on-lending). Specialized finance company 100 may be able to provide financing on more efficient terms than individual participants could realize elsewhere because finance company 100 may be able to realize benefits from its connection to the infrastructure of the marketplace and various arrangements and agreements it has with market participants 102, 104, 110. Participants 100, 102, 104 may work together to improve the efficiency of the market in receivables 106, for instance by agreeing to a common electronic form for receivables 106, or by providing preferential access to information, as discussed in sections III.G and III.H. Participants 100, 102, 104 may further increase these efficiencies by agreeing to tailor their rights and responsibilities and the terms of the financial assets 106 in a variety of ways, as described in section III.D. Finance company 100 may determine with the rating agencies the various parameters and terms under which finance company may aggregate and securitize receivables 106 generated in the B2B marketplace, as will be discussed in detail in section III.B.

Buyers 102 and sellers 104 may agree that the controlling records of receivables 106 are electronic records stored in a computer run as part of the infrastructure of the market in the underlying goods or services 108. Using a computer communications network, the seller/lender companies 104 holding those electronic notes may offer their notes 106 for sale to finance company 100. Finance company 100 may purchase notes 106, and then either sell notes 106 outright as whole loans to the capital markets 110, aggregate them into baskets 112 for sale to capital markets 110, or securitize baskets 112 of the notes to the capital markets 110. Finance company 100 may aggregate the notes to balance the credit and liquidity of the underlying notes 106 to raise the price it realizes for the securities 114 it sells to capital markets 110. Securities 114 issued to capital markets 110 may be backed by and will be paid from the proceeds of the notes 106, that is, from payments made by buyer/obligor companies 102. In the case where baskets 112 are securitized 118 to the markets, payments received from buyer/obligor companies 102 may be paid to capital markets investors 110 as principal and interest payments on the securities of the finance company 100.

Finance company 100 may determine, possibly in consultation with the rating agencies, the various parameters and terms under which finance company 100 may aggregate and securitize receivables 106 generated in the B2B marketplace. These parameters and terms may be a function of the contractual terms of the receivables 106, the credit risk of the buyer/obligor companies 102, the level of asset or obligor concentration, the size of the pools 112 of receivables available for financing, and so on. With this information and by monitoring pricing in the relevant portions of the capital markets 110, finance company 100 may provide ongoing pricing or financing terms to sellers/obligees 104 of receivables in the B2B market. In turn, finance company 100 may securitize the receivables (for instance in an asset-backed commercial paper program maintained by finance company 100) or obtain financing from a more traditional lender who would receive the benefits of aggregation, structuring and so on through the finance company and the various arrangements agreed to by the market participants.

The transaction may be structured to isolate investors 110 from the credit risk of the buyer/obligor company 102, so that the creditworthiness of securities 114 may be primarily dependent on the creditworthiness of the notes 106 backing the transaction and any related credit support arrangement provided to the transaction in order to absorb some or all of the credit risk inherent in notes 106. In contrast, an operating buyer/obligor company 102 may be subject to a wide range of changing risks in the marketplace. By isolating these uncertainties, operating company 102 may typically obtain a higher credit rating for a securitization than for a general obligation note issued with the same levels of capital and liquidity.

Communications facilities and other computer infrastructure may be provided to facilitate cooperation between finance company 100, buyer/obligor companies 102, rating agencies, sellers 104 of the notes, and/or the investors 110 in securities, to more efficiently negotiate the securities. By using finance company 100 to finance the notes 106 generated by a business-to-business exchange consortium, the participants in such a consortium may gain access to a more efficient source of financing than if they financed such notes through traditional channels.

By managing the flow of notes 106 into finance company 100 from sellers/obligees 104 and the kinds of securities 114 issued to capital markets 110, finance company 100 may provide financing for participants 102, 104 at a reduced cost of funds. Aggregating 112 of notes from multiple buyer/obligor companies 102 may reduce the risk premium of securities 114 relative to the interest rate on underlying notes 106.

The use of securitization to divide the cash flows from a pool of assets to create securities with different terms and maturities than the terms and maturities of the underlying assets may further reduce the cost of funds to participants 102, 104. For example, a pool of 30-year loans 106 can be used to back 3-year, 5-year, 7-year, 12-year and 30-year securities 114. The shorter term securities can pay less interest to capital market investors 110 than the underlying 30-year loans, permitting the excess interest to be sold to other investors for a profit. Conversely, a pool of revolving short-term assets, like credit card receivables, can be used to back securities 114 with a longer term, permitting more efficient financing for such revolving financial assets 106.

In the conventional market for trade debt, a seller/obligee 104 might take a portfolio of obligations to a bank, for example a small bank in the locale. Seller/obligee 104 may pledge the obligations as security, and borrow from the bank at some rate based more on that bank's cost of funds or the bank's deposits, perhaps 11%, than on the capital market cost of funds, which might be 7% or 8%. Because the bank may have little access to the capital markets, it may pay a very inefficient rate. Neither seller/obligee 104 nor the bank may be big enough, and seller/obligee 104 may not have the creditworthiness, to access the capital markets. In contrast, if seller/obligee 104 has the ability to borrow from finance company 100, which borrows directly from the capital markets 110, seller/obligee 104 may get close to capital market rates. The capital markets are the wholesale source of funds, the cheapest rate source of funds (except for occasional lenders that lend at a loss). The cost of funds between finance company 100 and sellers/obligees 104 may be significantly lower than the rates that each of those sellers/obligees 104 would have realized borrowing from their respective lenders. Some of the arbitrage, the savings realized by finance company 100, may be passed through to sellers/obligees 104. Some of the savings will be passed through to buyer/obligor companies 102. Some of the savings may be retained by finance company 100 to pay fees and expenses, and operating profit.

The availability of a finance company 100 need not preclude the use of traditional financing sources but finance company 100 may be more efficient than traditional financing sources, particularly where finance company 100 is organized and operated for the market and its participants 102, 104 generally rather than for particular market participants.

An electronic finance company 100 that is connected through a B2B marketplace's infrastructure to the buyers, sellers and other participants in such marketplace may provide financing for the market participants at to-date unseen efficiencies, as well as acting as a connecting channel between the marketplace and the capital markets. A specialized finance company 100 may provide access to securitization as a financing vehicle, further enhancing the access to credit and the capital markets by B2B market participants.

### II. Parties

Buyer/obligor companies 102 may be large companies with relatively comparable credit, within one or two rating notches of each other. For example, buyer/obligor companies 102 might be Ford, GM, Chrysler, Toyota, and Honda, and finance company 100 may be organized to manage receivables arising pursuant to their purchases of auto parts. In other examples, buyer/obligor companies 102 could be buyers of hard goods, retail goods, clothing, farm crops, or services. In other examples, buyer/obligor companies 102 could be companies borrowing to finance capital assets.

Sellers/obligees 104 may be auto parts manufacturers, manufacturers of goods, suppliers of raw materials or services to buyer/obligor companies 104, etc.

Typically, though not necessarily, buyer/obligor companies 102 may be participants in a relatively concentrated industry. As will be noted below, the operations of finance company 100 may be improved if there are a relatively small number of buyer/obligor companies 102, so that finance company 100 can develop good credit information about the obligor companies 102.

Finance company 100 may have a distinct legal existence, for example, incorporated as a special purpose entity (SPE) that is bankruptcy remote from buyer/obligor companies 102. Finance company 100 may act as the legal obligor on securities 114. Finance company 100 may be a business entity (for example, a corporation, limited liability company, or trust) owned cooperatively by either buyer/obligor companies 102, by sellers/obligees 104, or jointly by buyer/obligor companies 102 and sellers/obligees 104. In other cases, finance company 100 may not have a distinct legal existence, but may be operated through the cooperative efforts of a consortium of members 102 and/or 104.

Finance company 100 may operate though an internet web site that functions somewhat in the manner of a securities exchange, analogous to a NASDAQ electronic “trading floor,” trading the notes and/or receivables 106 of buyer/obligor companies 102. The finance company's internet site may be available to buyer/obligor companies 102, to sellers/obligees 104, and to investors 110. Finance company 100 may provide different amounts of information access to different participants 102, 104, 110. For example, a particular buyer/obligor 102 may have access to all information about notes 106 of that buyer/obligor, but less information about receivables of other buyer/obligor companies 102. Information about a given note 106 may be kept relatively closely held while note 106 is held on the books of finance company 100 exclusively for the benefit of a given seller/obligee 104, but more information may be made publicly available once a seller/obligee 104 chooses to sell note 106.

Finance company 100 may serve as a conduit vehicle to access the capital markets 110 to issue highly-rated securities 114 that might be backed by financial assets 106 from a diverse group of different buyer/obligors 102 of financial assets. Where a traditional market is typically highly decentralized and fragmented, with different sellers dealing one on one with their buyers, finance company 100 may provide a “standardized” product. Because the terms and sales channel may be standardized and fairly routine, the financing of notes 106 may be more efficient, with lower costs for sellers. A rating agency may be able to view the market made by finance company 100 in a standardized manner, so that the rating agency can develop better information on securities 114 offered through finance company 100. This improved information may reduce the risk to investors 110, and thereby reduce the risk premium demanded by investors 110, with a consequent improvement in cost of funds to sellers 102, 104.

Finance company 100 may finance itself by retaining a holdback, or “haircut,” out of the proceeds on sale of securities 114. (A haircut is a discount rate, or up-front fee at the time of the offering. For example, on $10,000 worth of notes, finance company 100 may only pay seller/obligee 104 $9,950. The $50 discount covers interest on the securities that the finance company 100 issues to the market, principal, and program fees and expenses.) This holdback may include program fees, and cover the finance company's cost of funds, its internal costs and expenses, etc., and may insure finance company 100 against potential charge-off issues, delinquencies, defaults, interest rate and market price fluctuations, and other market risks, and may in some cases generate an operating profit. Some of the holdback may be paid to the buyer/obligor companies 102, and/or some may be paid to seller/obligee companies 104.

The parties in capital markets 110 that purchase the securities 112, 116, 118 may draw funds from savings deposits, insurance premium payments, and the like.

### III. Finance Company Activities

III.A. Flow of Funds

When buyer/obligor 102 purchases goods or services from seller/obligee 104 (or otherwise borrows from seller/obligee 104), buyer/obligor 102 gives a note 106 to seller/obligee 104, typically due in 30, 60 or 90 days, to the account of seller/obligee 104 at finance company 100. Where a traditional receivable might have been delivered to seller/obligee 104 as a signed writing, sellers/obligees 104 may agree to accept credit entries on the computer system of finance company 100, as the authoritative record of receivables between seller/obligees 104 and buyer/obligor companies 102. This bookkeeping may be straightforward, because of the close relationship between buyer/obligor 102 and finance company 100. Finance company 100 may acknowledge the credit of the note to seller/obligee 104 through the internet.

Participation by seller/obligee companies 104 in the finance company 100 may be optional, and seller/obligees 104 may be free to request receivables in the traditional form of a signed writing. Even if the receivable 106 is received through finance company 100, a seller/obligee 104 may be free to finance receivables 106 through a traditional channel, such as factoring. Alternatively, buyer/obligor companies 102 may specify that finance company 100 is the only or preferred method of payment. Sellers/obligees 104 may find it beneficial to accept payment through finance company 100 because the market made by and alternative financing methods made available through financing company 100 may be more efficient than traditional factoring. This efficiency may translate into a higher price paid to seller/obligee 104—for instance, where a traditional factor may pay 90% of par value for a given receivable, finance company 100 may be able to pay 95% of par value.

The bookkeeping for notes 106 may be coupled with other business-to-business (or “B2B”) markets, particularly (but not necessarily or exclusively) in the context of a B2B market organized among a consortium of buyers 102 and sellers 104 for auto parts, retail goods, crops, or other assets. Transactions in these B2B markets may generate a high volume of receivables 106 for which buyer/obligor companies 102 are account parties.

A seller/obligee 104 may make an inquiry at finance company 100 web site to find records of notes credited to the seller/obligee's account. Finance company 100 may present seller/obligee 104 with a number of available financing options. Seller/obligee 104, may wait, with the record remaining on the computer of finance company 100, until buyer/obligor 102 redeems the note 106 for cash at the due date. Seller/obligee may receive the note 106 in negotiable form to sell or borrow against, outside the auspices of finance company 100.

Alternatively, finance company 100 may offer to sell note 106 to the capital markets on behalf of seller/obligee 104, or may offer to buy the note 106 outright for its own account, or to buy the notes 106 to replace notes that have come due and been redeemed by buyer/obligor companies 102 within a revolving pool 112 of securities previously issued by finance company 100. Finance company 100 may offer several different sets of terms, varying based on upcoming offerings that finance company 100 plans to offer to the market, or its needs to replace redeemed securities. For example, finance company 100 may offer 5-year notes, at a particular spread relative to the 30-year treasury rate, 30-, 60-, and 90-day notes, etc. In some cases, finance company 100 may offer a periodic payment plan to seller/obligee 104. Finance company 100 may offer several different options to seller/obligee 104 at different prices, depending on the basket 112 into which the note is to be grouped. The capital structure and the characterization of the securities 114 to be issued depend on rating agency criteria applicable to the securities being issued, the characteristics of the portfolio, and other factors. Finance company 100 may take these features into account, and attempt to increase diversification of the companies 102 represented in the baskets 112 while preserving homogeneity of the assets as discussed in sections III.G and III.C. Assuming that seller/obligee 104 chooses to finance note 106 though finance company 100, the finance company's computer system may offer a cash price for the note 106, or may offer other prices for future sale. This price may be more favorable to seller/obligee 104 than the price in the conventional market, because finance company 100 may have current, thorough information on the individual buyer/obligor companies 102, and may be able to readily evaluate the credit quality of the particular buyer/obligor 102, and the quality of note 106.

Finance company 100 accepts the note easily, and may be able to forego a credit check on obligor/buyer/obligor 102, because of the close and continuing knowledge by finance company 100 of the credit status of buyer/obligor 102 (see section IV). This credit information may be especially reliable in cases where buyer/obligor members 102 are the sponsors of finance company 100. Finance company 100 may not have to obtain a credit check of seller/obligee 104, because the note is backed by buyer/obligor 102, and finance company 100 already has possession of the asset, and may have a preferential relationship with buyer/obligor 102 104 that may facilitate collecting on the note 106.

III.B. Aggregating Notes for Securitization

After purchasing notes 106 from sellers/obligees 104, finance company 100 may package note 106 with others and sell it to the capital markets 110.

The efficiency of securitization 118 may be improved by increasing the homogeneity of the assets 106, for example, by standardizing the terms of notes 106. For example, finance company 100 may establish standards, communicated to buyer/obligor companies 102, for those notes that finance company 100 will accept for financing. Notes 106 that observe certain standard terms may be more easily packaged and sold to the capital markets. The efficiency of the securitization may also be improved by diversifying concentration of underlying obligors 102 and industry categories. The greater the efficiency of a securitization the higher the price that can be charged in the market, and the lower the spread between the price obtained in the market and the price paid to participants 102, 104, and the lower the cost of funds for participants 102, 104.

A finance company or vehicle 100 that is organized to provide a market for notes 106 and is integrated with the B2B platform for goods or services may be capable of efficiencies of specialization. Buyer/obligor companies 102 may be able to shape the financing program provided by finance company 100 and/or tailor their own obligations 106 to meet rating agency criteria, which in turn may improve the price received in a sale or securitization of the notes 106. Finance company 100 and participants 102, 104 may adjust the capital structure of the notes in a particular basket 112, the characteristics of the portfolio, and the characterization of the securities 114 to be issued in order to obtain favorable ratings from rating agencies for the issued securities.

III.C. Maintaining Portfolio Balance

Finance company 100 may aggregate notes 106 from several buyer/obligor companies to mitigate geographic and obligor concentration risk. Alternatively, finance company 100 may aggregate notes 106 into tranches of varying risk. Finance company 100 may use the price it pays to seller/obligees 104 to manage the mix of notes in baskets 112.

Finance company 100 might offer multiple options to seller/obligee 104, based on the following factors. Because there may be multiple buyer/obligor companies 102, and hundreds of different sellers/obligees 104 selling goods and/or services 108 to these members, there may be different mixes of these notes 106 offered to finance company 100 on any given day. Finance company 100 may attempt to put together a beneficial mix of assets and trancheing based on the rating agency criteria as that mix meets or misses an optimal mix. For example, a rating agency may rate a given security offered by finance company 100 based on an assumption that 60% of it is backed by buyer/obligor A obligations, and 20% by obligations of buyer/obligor 102 B, and 20% by obligations of buyer/obligor C.

In one example, finance company 100 may set a target mix of A, B, and C at 60%, 20%, and 20%, to mitigate of concentration risk-the obligation of A is diversified against obligations of B and C. Diversification reduces the default rate risk. By reducing risk, finance company 100 may be able to reduce the ‘haircut’ on the deals, taking out some of the risk premium.

Efficiency may also be improved because the rating agency has specialized information about buyer/obligor companies 102. If finance company 100 needs additional information about the obligations 106, finance company 100 may have preferential access to buyer/obligor companies 102 as discussed in section IV, infra.

In addition to the terms and tenor of the security being sold, the baskets 112 may vary according to the financial assets backing those securities, based on the selling activity of the other sellers/obligees 104 selling their financial assets into finance company 100. For example, returning to the example of a basket 112 with a target of 60% A, 20% B and 20% C, assume that the current basket 112 is half full, currently holding 60% receivables of buyer/obligor 102 A, 30% B, and only 10% C. This basket 112 is a little out of balance to the desired mix, with too many B assets and too few C assets. Finance company 100 may attempt to correct this imbalance by adjusting the haircut, and the price paid for notes 106. When the basket 112 is already out of balance and the new asset would add to the imbalance, then the haircut will be a little greater, and the offered price a little lower. In this example, finance company 100 may offer seller/obligees 104 a slightly lower price for receivables of buyer/seller B. Finance company 100 may offer a higher price, a lower haircut, on assets of buyer/obligor 102 C (that is below the target). It is acceptable for the basket 112 to be off the desired balance, but the rating agency may require that the haircut be a little larger, and the price offered to seller/obligee 104 a little lower, to reflect the increased concentration risk.

Finance company 100 may currently be filling several baskets 112, varying by priority tranche, or different maturities of the security, etc. By filling several baskets 112 simultaneously, finance company 100 may raise the chance that the offered receivable makes a positive contribution to balance and diversification of at least one of the baskets 112. This may raise the price that finance company 100 can offer to seller/obligee 104.

Usually, finance company 100 will offer seller/obligee 104 a price that seller/obligee 104 can accept, and seller/obligee 104 will accept the offer, and finance company 100 will electronically transfer the agreed price on overnight settlement, or whatever terms the parties agree.

In some cases, all of the medium term (e.g. five year) baskets 112 may be over-weighted with the receivable offered by buyer/obligor 102, and the price offered by finance company 100 will be relatively low. In this case, seller/obligee 104 will likely simply decline to sell. Finance company 100 may offer an alternative, e.g., 30 day commercial paper; seller/obligee 104 may exchange the receivable 106 for 30 day commercial paper, and hope that there will be a more favorable basket 112 available 30 days later when the receivable comes back.

Finance company 100 may offer a “queue holder” option, under which seller/obligee 104 acquires first-in-time priority to join the next medium term basket 112.

Finance company 100 may require buyer/obligor companies 100 to use credit bolstering techniques, as discussed in III.D.

Seller/obligee 104 may be exposed to a new kind of demand risk, that certain receivables will be more valuable to finance company 100 at certain times, and less valuable at other times, depending on what receivables are already in the existing baskets 112. However, this effect is only a mirror of the more conventional demand risk—paper that is in oversupply has a lower price. The effect may be significantly smaller than the benefit to seller/obligee 104, and a seller 104 retains the option to factor the receivable in the conventional manner, if a factor will give a better spread than finance company 100. First sellers into new baskets 112, and sellers of securities that are under-weighted in the current basket 112, will benefit. If and when a basket 112 starts tipping up over the optimal, sellers 104 of over-weighted securities may get less favorable pricing. Finance company 100 may attempt to reduce these fluctuations, by allowing sellers to wait until a new basket 112 is started, or increasing or reducing the size of the basket 112 to try to create a smaller basket 112 whose proportions are more easily balanced. Finance company 100 may adjust target weightings of baskets 112.

III.D. Improving the Mix of Receivables and Notes Offered for Financing

Participants 102, 104, 110 may cooperate to define the terms of receivables 106 to improve the efficiency of financing them. For example, efficiency may be improved by reducing features that may impair the timing or amount of payments to be made on a securitized asset 106. As particular examples, buyer/obligor companies 102 may waive certain legal defenses to payment or collection or may waive certain debtor right, and/or may assume an obligation to pay interest on unpaid amounts by certain dates Buyer/obligor companies 102 may make certain representations and warranties. Buyer/obligor 102 may tailor the timing of events of default, and/or may allow the assets to be held by a collateral agent. A seller/obligee 104 who seeks to finance receivables within the marketplace may be deemed to have made certain representations and warranties regarding the seller, the receivables and transfers of interests therein. Participants 100, 102, 104 may agree to use of certain generic terms.

There may be circumstances such as credit issues, liquidity issues and credit ratings that affect the mixing of notes. For example, if one buyer/obligor 102 is BBB rated and the rest of buyer/obligor companies 102 are A rated, the BBB buyer/obligor 102 could reduce the term of its notes 106 in order to help bolster the credit-worthiness of its notes and to get close-to-equivalent treatment. This may be triggered by notice from the rating agency or from finance company 100, when the agency or finance company 100 notices the weakened credit and threatens to increase the haircut on buyer/obligor company's notes. Other peculiarities that effect the rating of the note 106 can be bolstered, in one of a variety of ways, in order to achieve a similar rating, and bring the note into line with the other notes in the basket 112.

A specific buyer/obligor 102 may have a specific credit problem, and become a weaker credit. By reducing the structure's exposure to the individual weakened buyer/obligor 102, the membership as a whole benefits from the improved stability of the consortium's credit. Buyer/obligor companies 102 may waive certain defenses on their notes, accelerate the payment terms of their notes 106, add additional covenants, remove other ambiguities, make specific care-outs or additions to a package, or otherwise mitigate risks perceived by the rating agency, in order to bolster the credit quality of the securities that are sold.

Finance company 100 may have a cost of funds lower than the cost of funds of buyer/obligor companies 102 themselves. Each individual buyer/obligor 102 may be rated A or BBB. The aggregation and credit enhancing performed by finance company 100 may generate AAA rates.

III.E. Pricing Notes

Finance company 100 may determine the price that it wishes to pay for notes 106 by any conventional method; additional methods may be derived for particular use by a finance company 100 serving a consortium. For example, note 106 may be priced by the “dead reckoning” of a human being. Computer software may price the note, using a valuation formula that discount the note by an interest rate reflecting the credit risk of buyer/obligor 102, and a risk premium reflecting uncertainties and volatility in the market, e.g.,

price=face×(1−r₁−r₂)^{t}×(1−r₃)−r₄

where

price is the price paid by finance company 100 to seller/obligee 104

face is the face amount of the note 106

r₁ is the risk-adjusted discount rate that the market 110 assigns to like-seniority obligations of buyer/obligor 102

r₂ is a further risk-adjustment discount rate that finance company 100 may apply, reflecting risks assumed by finance company 100—e.g., price or rate volatility risks reflecting the time between when the note is purchased from seller/obligee 104 until it is sold to the market

r₃ and r₄ are discounts out of which finance company 100 takes a profit and administrative fee.

t is the time to maturity of the security

Any one, two or three of r₂, r₃ and r₄ may be zero, or may scale with the face value.

The price paid by finance company 100 for notes 106 may also reflect rating agencies' evaluation of the buyer/obligor 102, on the current mixes of the current baskets 112, etc. Any price that is higher than the price offered by factors or banks will likely be attractive to seller/obligee 104; any price that is low enough to leave a profitable spread over the capital markets lending rate, and to cover the finance company's costs, may be acceptable to finance company 100.

The amount of the holdback may be limited so that the transaction will be treated as a true sale, rather than a financing. Under some accounting rules, if party A buys an asset with a face value of $100 from party B for only $50, and promises that the remaining $50 of the note will be given to party B when the note pays off, the transaction may be treated as a loan where A lent $50 to B, and B pledged assets worth $100 on a nonrecourse basis. To avoid the effect of this accounting rule, the holdback must not be too large, so that the transaction will be characterized as a sale rather than a financing. The distribution of the holdback among the seller/obligee 104, the buyer/obligor 102, and finance company 100 may be divided to achieve a desired characterization of the transaction, to compensate for risk incurred by each party, to reflect the time value of money, and to provide some profit to finance company 100 and its parent companies.

III.F. Offerings by Finance Company to the Capital Markets

Securities 114 offered by finance company 100 to the capital markets 110, that is, the baskets 112, may vary with a number of factors. For example, if the underlying goods are farm goods and the notes 106 are the typical notes due to farmers from agriculture companies, and due to seed companies from farmers, the tenor of the notes 106 may tend to be longer than in the automobile parts scenario discussed above, and the trading may be much more seasonally clustered. Thus, finance company 100 may make its offerings 114 daily during peak times, and bi-weekly during slower seasons. The baskets 112 may vary with the underlying notes in the baskets 112.

In some industries, the standard terms for notes may be longer than in others, and this may lead to finance company 100 tending to offer longer term securities 114. In some industries, the variability of the credit risk among buyer/obligor companies 102 may be greater than in others; finance company 100 may package notes 106 to produce a more marketable basket 112.

When finance company 100 sells a longer term security 112 backed by shorter term notes 106, securities 114 will be backed by a continuous sale of new notes 106. As a note 106 is paid off, finance company 100 may use the cash to buy new notes 106. For example, if finance company 100 sells $100 of securities 112 today, the next time $100 of notes 106 were purchased from seller/obligee companies 104, no more securities 114 would be offered to the capital markets 110; rather the cash would be used to buy new notes 106 to back existing securities 114.

Securities 114 may be tranched to allow different investors 110 to buy or exclude more or less risk. In some cases, securities 114 in the varying tranches may all pay periodic interest payments, with the tranches varying in their priority claims on payments made by buyer/obligor companies 102. In other cases, securities 114 may vary in their tenor—the senior-most tranche has a claim on all cash flows from underlying notes 106, until the securities 114 are paid off. Then the next tranche has a claim on all cash flows from notes 106. The junior-most tranche may receive nothing until all other tranches are paid in full.

III.G. Record-Keeping and Secondary Market

Participants 102, 104, 110 may agree that the records of finance company 100 are the legally-binding records of ownership of notes 106. The ease in establishing ownership and the ease of settlement engendered by centralized electronic storage of ownership information may facilitate the creation of a secondary market in notes 106.

The creation of finance company 100 by a consortium of high-volume buyer/obligor companies 102 and making a market in a class of notes of buyer/obligor companies 102 may effectively compel participation by sellers/obligees 104.

Improved availability and cost of funds for buyer/seller companies 102 and seller/obligees 104 may, improve the viability of a market in notes 106.

In some embodiments, the records of notes 106 may be stored in the form of “transferable records,” as that term is defined in UETA (the Uniform Electronic Transactions Act), or “authoritative copies” as that term is defined in §9-105 of the 1999-2001 revision of the Uniform Commercial Code. One example implementation of “transferable records” or “authoritative copies” is disclosed in U.S. Provisional Application for Patent Serial No. 60/264,590, filed Jan. 26, 2001, Steven Orrin et al., “Electronic Representation Of Obligations,” incorporated herein by reference.

In other embodiments, the records of notes 106 may be recognized as the authoritative representation of notes 106 as a trade practice, or as a matter of contract among parties 100, 102, 104.

In some implementations, sellers/obligees 104 may, on request, obtain a conventional paper signed writing evidencing obligation 106 in exchange for, or in lieu of, the electronic record.

III.H. Leveraging of Technological Infrastructure

Finance company 100 may be especially efficient in a market where an organized electronic trading system for the underlying real goods is already in place among the businesses involved. With that trading system in place, the information to track the financial assets 106 may already be present in the computer systems in a relatively uniform format, and readily leveraged for use by finance company 100.

With finance company 100 and its technological infrastructure in place, participants 102, 104, 110 may be able to leverage that infrastructure to additional benefit. For example, the same technological platform and database used to transact the sales of goods or services that give rise to the notes 106 may be made available to sellers to offer their notes 106 to the financing vehicle 100, and to finance company 100 in evaluating and agreeing to include such assets in an offering 114. The connection of these databases and sharing of information may permit the instantaneous calculation and display of price that seller 104 could receive for its notes 106, which might be based on the mix of notes that had been acquired so far in putting together a basket 112 for financing, but would not require significant re-underwriting or credit checks or evaluation of terms, etc. The use of the internet to create interlinked virtual markets may permit offers to be rapidly made and accepted with respect not only to purchases of goods but also the financing of the notes 106 generated by the sales, thus providing buyers and sellers with powerful new methods for determining whether a transaction makes sense. The use of cookies and of frequent updating of the information in the internet server may permit the network to make trading decisions at computer trading speeds.

Finance company 100 may have access to read the electronic records that constitute the receivables 106 generated in the marketplace and authority to transfer or mark the receivables 106 as necessary to finance the receivables 106 once a seller/obligee 104 has chosen to do so through finance company 100.

III.I Secondary and Derivative Markets

The securities issued by finance company 100 to capital markets 110 may spawn a secondary market, and markets in derivatives. Finance company 100 may trade in derivatives to hedge its own risks. Finance company 100 may use structured notes and derivatives in order to rebalance a basket 112. For example, if a basket 112 has a misallocation, a 70% A/20% B/10% C allocation instead of a desired 60%/20%/20% allocation, finance company 100 may buy and sell structured notes and derivatives to rebalance basket 112, to bring up the 10% and bring down the 70%. Buyer/obligor companies 102 might establish an inter-bank arrangement among themselves to mitigate misallocation risks and maintain that efficiency. For example, buyer/obligor companies A, B and C may have an inter-bank arrangement with notes or obligations on “deposit” with finance company 100 (finance company 100 may act in a manner analogous to an issuing agent). Finance company 100 may have the right to takedown $10 of obligations of buyer/obligor C and use them to “purchase” for C's account $10 worth of obligations of buyer/obligor A from basket 112. By replacing obligations of A with obligations of buyer/obligor C in basket 112, basket 112 may be brought into better balance. By maintaining an efficient mix and efficient pricing, these activities of finance company 100 may benefit the whole market. Similarly, this arrangement may ameliorate injury to the other buyer/obligor companies in cases where C may not be generating its expected share of market obligations and therefore may be the cause of the inefficiency.

Parties 100, 102, 104 may have agreed procedures for. Finance company 100 may have other trading management and balancing mechanisms to keep the flow of securities near a desired mix of buyer/obligor 102 obligations into this vehicle, to mitigate interest rate risk (between the rates borne by the securities issued by the finance company and the receivables) and currency risk. For instance, finance company 100 may manage the types of securities issued, and/or may use derivative transactions, total rate of return swaps and credit linked notes, credit enhancements, interest rate exchange agreements and currency exchange agreements.

Finance company 100 may use traditional lending methods to obtain liquidity and to deal with aggregation risks (e.g., the collecting of enough notes proposed for financing prior to a securitization by the financing organ).

IV. Improved Credit Information, Relationships with Rating Agencies

A closed system of buyer/obligor companies 102 and/or seller/obligee companies 104 may reduce the need to diligence the credit of account parties. This may further reduce transaction costs below those that would obtain in a transaction where a an intermediary, e.g., an investment bank, has no special prior knowledge of the buyer/obligor companies. Obligor companies 102 may have incentives to provide and update their credit information with finance company 100, to improve the evaluation given by rating agencies. This additional information may allow other parties to more correctly evaluate risks, and more accurately price the transactions. Rating agencies may be allowed to analyze a large specialized program and may design rating criteria specific to the program, creating new efficiencies.

Finance company 100 may have more knowledge about the assets and the buyer/obligor companies 102 than any other lender, and may be able to use that information to aggregate the collateral and mitigate concentrations in ways unavailable to other lenders. For example, in cases where finance company 100 is constituted by buyer/obligor companies 102, the relationship between buyer/obligor companies 102 and finance company 100 may be less adversarial than the traditional relationship between an obligor and its finance agent, and a buyer/obligor 102 may be more forthcoming with certain information. For example, if buyer/obligor were to contest its obligation on a note 106 (e.g., that the note is not due, or some other defense), that information might be made available to finance company 100, so that finance company 100 would not offer the contested note to the capital markets 110. In some cases, a consortium agreement amount buyer/obligor companies 102 may require such disclosure, and/or finance company 100 may have resources to validate the claim. Accordingly, finance company 100 may be able to provide financing for the assets more efficiently than any other lender. In doing so, finance company 100 may be able to pass back to buyer/obligor companies 102 and/or seller/obligee companies 104 some of the advantage and pass some of the advantage to the sponsors in the form of program fees and arbitrage profit.

The financing provided by financing company 100 may be sufficiently attractive to buyer/obligor companies 102 or seller/obligee companies 104 to create extra incentives for them to remain in good standing in the virtual market, and to fully and timely perform their obligations as sellers into the securitization program of finance company 100.

The known criteria and closed universe of obligors (buyer/obligor companies 102) may permit specialized lending criteria. For example, advance rates may be established for each buyer/obligor 102 on a stand-alone basis, and for various baskets 112 of members' obligations. Seller/obligee companies 104 making sales and turning to finance company 100 for financing may be offered immediate loans based on the advance rates (an “advance rate” is the percentage of par that a lender will lend against an asset. For instance, most real estate loans require 10% down, which is the same as a 90% advance rate) applicable to the subscriptions then in the system (e.g., there may be sufficient requests for advances in the queue that loans can be made at a more favorable advance rate). If a given advance rate is not efficient at the time of request (e.g. due to a lack of subscriptions for loans), seller/obligee 104 may be allowed to put its name on a list waiting giving it priority over others for entry of its notes into a new basket 112 that is being aggregated for securitization or a derivative or structured financing.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

I claim:

1. A method, comprising the steps of:
chartering a business entity to acquire or finance receivables of members of a defined group of competing independent buyer/obligor companies, the business entity being under cooperative operation of several of the buyer/obligor companies;
in cooperative consultation among the buyer/obligor companies and the business entity, defining terms of receivables of the buyer/obligor companies, the definition of terms being directed to improving efficiency of financing the receivables;
in payment for goods or services sold by obligee companies to buyer/obligor companies, issuing receivables of buyer/obligor companies to obligee companies in the form of book entries on a computer system operated by the business entity, the business entity accepting custody of a majority of a class of receivables of the buyer/obligor companies to creditor companies, the receivables being recorded as book entries on a computer system that also functions as a business-to-business platform for the sales of the goods, the obligee companies agreeing to accept such book entries as the controlling record of the receivables;
extending offers from the business entity to holders of the receivables for purchase of the receivables;
selling in the capital markets securities backed by cash flows from receivables purchased pursuant to the offers; and
operating a market for trading of the receivables by providing computer access to inventory information and order placement facilities.

2. A method, comprising the steps of:
chartering a business entity to acquire or finance financial instruments issued by members of a defined group of competing independent businesses;
in cooperative consultation among the independent businesses and the business entity, defining terms of financial instruments of the independent businesses to be issued to creditors, the definition of terms being directed to improving efficiency of financing the financial instruments.

3. The method of claim 2, wherein the financing includes offering aggregated baskets of financial instruments issued by two or more of the independent businesses in the capital markets.

4. The method of claim 2, wherein the defined terms include waiver by the independent businesses of defenses to payment or collection of the financial instruments.

5. The method of claim 2, wherein the defined terms include the addition of representations and warranties to the financial instruments.

6. The method of claim 2, wherein the defined terms include standardizing terms of financial instruments issued by all members of the group of independent businesses.

7. The method of claim 2, further comprising the step of:
extending offers from the business entity to holders of financial instruments issued by the independent businesses for purchase of the financial instruments.

8. The method of claim 7, further comprising the step of:
selling in the capital markets securities backed by cash flows from financial instruments purchased pursuant to the offers.

9. The method of claim 7, further comprising the step of:
the obligor companies agreeing to preferentially disclose credit information describing themselves to the entity.

10. The method of claim 7, further comprising the step of:
aggregating a plurality of purchased financial instruments for offer of a securitization in the capital markets.

11. The method of claim 10, further comprising the step of:
simultaneously assembling at least two baskets of the instruments for securitization in the capital markets as two separate securities.

12. The method of claim 2, further comprising the step of:
accepting custody in the business entity of a majority of a class of financial instruments issued by the independent businesses, the business entity also serving as the recorder of the current ownership of the financial instruments.

13. The method of claim 12, further comprising the step of:
operating a market for trading of the instruments by providing computer access to inventory information and order placement facilities.

14. Tile method of claim 2, further comprising the step of:
seller companies agreeing to accept book entries on a computer system as the controlling record of financial instruments arising out of sale of goods or services from the seller companies to the independent businesses.

15. The method of claim 2, further comprising the step of:
the computer system also hosts a business-to-business platform for the sales of the goods or services.

16. The method of claim 2, further comprising:
in cooperative consultation among the independent businesses, the business entity, and a commercial rating agency, defining terms of financial instruments of the independent businesses to creditors, the definition of terms being directed to improving efficiency of financing of the financial instruments.

17. A method, comprising the steps of:
extending offers from a business entity to holders of financial instruments of obligor companies for purchase of the instruments, the business entity being under cooperative operation of several independent companies; and
selling in the capital markets securities backed by cash flows from instruments purchased pursuant to the offers.

18. The method of claim 17, wherein:
the business entity is cooperatively owned by a plurality of the obligor companies.

19. The method of claim 18, wherein:
the obligor companies are a defined group of competing businesses, the instruments being receivables arising out of purchase from the obligees of inputs to the obligor companies.

20. The method of claim 18, further comprising the step of:
selling goods from a plurality of seller companies to a plurality of the obligor companies, the financial instruments being receivables of the obligor companies in payment for the goods.

21. The method of claim 20, further comprising the step of:
storing records, agreed by the obligor and obligee companies to be the controlling record of the receivables, on a computer system that also functions as a business-to-business platform for the sales of the goods.

22. The method of claim 18, further comprising the step of:
selling in the capital markets securities backed by cash flows from an aggregated basket of the purchased instruments.

23. The method of claim 22, further comprising the step of:
simultaneously assembling at least two baskets of the instruments for securitization in the capital markets as two separate securities.

24. The method of claim 18, wherein the selling of securities includes offering aggregated baskets of financial instruments issued by two or more of the obligor companies in the capital markets.

25. The method of claim 24, further comprising the step of:
simultaneously assembling at least two baskets of the instruments for securitization to the capital markets as two separate securities.

26. The method of claim 18, further comprising the step of:
among the business entity and the obligor companies, cooperatively defining terms of financial instruments of the obligor companies.

27. The method of claim 26, wherein the defined terms include waiver by the obligor companies of defenses to payment or collection of the financial instruments.

28. The method of claim 26, wherein the defined terms include standardizing terms of financial instruments issued by all members of the group of obligor companies to be sold in the capital markets through the business entity.

29. The method of claim 18, further comprising:
in cooperative consultation among the obligor companies, the business entity, and a commercial rating agency, defining terms of financial instruments of the obligor companies to creditors, the definition of terms being directed to improving efficiency of financing of the financial instruments.

30. A computer system, comprising:
a purchase interface comprising circuitry and/or software designed to extend offers from a business entity operating the computer to holders of financial instruments of obligor companies for purchase of the instruments, the business entity being under cooperative operation of several independent companies; and
a sales interface comprising circuitry and/or software designed to implement sales in the capital markets of securities backed by cash flows from instruments purchased pursuant to the offers.

31. The computer system of claim 30, wherein:
terms of financial instruments of the independent businesses to creditors have been cooperatively defined among the business entity and the obligor companies, the definition of terms being directed to improving efficiency of the sales to the capital markets.

32. The computer system of claim 30, wherein:
the obligor companies agree to preferentially disclose credit information describing themselves to the entity.

33. The computer system of claim 30, wherein:
the business entity is chartered by at least some of said obligee or obligor companies as custodian for the financial instruments.

34. The computer system of claim 33, wherein:
the obligee companies have agreed to accept book entries on the computer system as the controlling form of the instruments.

35. The computer system of claim 33, wherein:
the business entity accepts custody of a majority of a class of the financial instruments of the obligor companies to the obligee companies; and
the computer system supports a market for trading of the instruments by providing computer access to inventory information and order placement facilities.

36. A method, comprising the steps of:
selling goods and/or services from a plurality of seller companies to a plurality of buyer companies, the buyer companies issuing receivables to the seller companies in payment for the goods and/or services, the recording of the receivables being recorded on a computer system that also functions as a business-to-business platform for the sales of the goods and/or services.

37. The method of claim 36, further comprising the step of:
extending offers from a business entity to holders of the receivables for purchase of the receivables, the business entity being under cooperative operation of several independent ones of the buyer companies.

38. The method of claim 37, further comprising the step of:
operating a market for trading of the receivables by providing computer access to inventory information and order placement facilities.

39. The method of claim 38, further comprising the step of:
offering aggregated baskets of receivables issued by two or more of the independent businesses in the capital markets.

40. The method of claim 39, further comprising the step of:
simultaneously assembling at least two baskets of the receivables for securitization to the capital markets as two separate securities.

41. The method of claim 37, further comprising the step of:
the buyer companies waiving defenses to payment or collection of the receivables.

42. The method of claim 37, further comprising:
in cooperative consultation among the buyer companies, the business entity, and a commercial rating agency, defining terms of the receivables of the buyer companies to the seller companies.

43. The method of claim 36, further comprising the step of:
the buyer companies agreeing to preferentially disclose credit information describing themselves to the entity

44. The method of claim 36, further comprising the step of:
the buyer companies agreeing to accept book entries on a computer system operated by the business entity as the controlling record of the receivables.

45. A computer system, comprising:
a business-to-business transaction platform comprising circuitry and/or software designed to provide a market for sale of economic inputs from a plurality of seller companies to a plurality of buyer companies; and
a recording module comprising circuitry and/or software interconnected with the business-to-business transaction platform and designed to record the sole legally-effective record of receivables of the buyer companies to the seller companies in payment for the inputs.

46. The computer system of claim 45, wherein:
terms of financial instruments of the buyer companies to the seller companies have been cooperatively defined among the business entity and the buyer companies, the definition of terms being directed to improving efficiency of the sales in the capital markets.

47. The computer system of claim 45, further comprising:
a purchase interface comprising circuitry and/or software designed to extend offers from a business entity operating the computer to holders of the receivables for purchase of the receivables, the business entity being under cooperative operation of several independent companies.

48. The computer system of claim 45, further comprising:
a purchase interface comprising circuitry and/or software designed to extend offers to purchase receivables of the buyer companies for purchase from the seller companies of inputs to the buyer companies.

49. The computer system of claim 48, further comprising:
a sales interface comprising circuitry and/or software designed to effect sale in the capital markets of securities backed by cash flows from instruments purchased pursuant to the offers.

50. A method, comprising the steps of:
a plurality of obligee companies agreeing to accept book entries on a computer system operated by a business entity as the record form of financial instruments arising out of the purchase of goods or services sold by the obligee companies to obligor companies, the entity chartered by at least some of said obligee or obligor companies as custodian for the instruments.

51. The method of claim 50, wherein the obligee companies and obligor companies have agreed that the book entries are to be regarded as the record form of the financial instruments, in preference to a signed writing.

52. The method of claim 50, further comprising the step of:
extending offers from the business entity to holders of the financial instruments for purchase of the instruments.

53. The method of claim 50, further comprising the step of:
cooperating, among the business entity and the obligor companies, to define terms of the financial instruments.

54. The method of claim 53, wherein the defined terms include waiver by the obligor companies of defenses to payment or collection of the financial instruments.

55. The method of claim 53, wherein the defined terms include the addition of representations and warranties to the financial instruments.

56. The method of claim 53, wherein the defined terms include standardizing terms of financial instruments issued by all members of the group of obligor companies.

57. The method of claim 53, further comprising:
in cooperative consultation among the obligor companies, the business entity, and a commercial rating agency, defining terms of financial instruments of the obligor companies to creditors.

58. The method of claim 52, further comprising the step of:
selling in the capital markets securities backed by cash flows from instruments purchased pursuant to the offers.

59. The method of claim 50, wherein the selling includes offering aggregated baskets of financial instruments issued by two or more of the obligor companies in the capital markets.

60. The method of claim 50, wherein the obligor companies are a defined group of competing businesses.

61. The method of claim 50, further comprising the step of:
the business entity accepting a majority of a class of financial instruments issued by the obligor companies for storage and recording in the computer system.

62. The method of claim 50, further comprising the step of:
operating a market for trading of the instruments by providing computer access to inventory information and order placement facilities.

63. A computer system, comprising:
a storage module designed to store book entries of financial instruments issued by obligor companies to obligee companies, the instruments arising out of purchases of goods or services sold by the obligee companies to the obligor companies;
wherein the computer system is under the control of a business entity chartered by at least some of the obligee or obligor companies to act as custodian for the instruments.

64. The computer system of claim 63, wherein the obligee companies and obligor companies have agreed that the book entries are to be regarded as the record form of the financial instruments, in preference to a signed writing.

65. The computer system of claim 63, further comprising:
a business-to-business transaction platform comprising circuitry and/or software designed to provide a market for the purchases of the goods or services, the business-to-business transaction platform being interconnected with the storage module to automatically effect storage of the instruments on closing of the purchases.

66. The computer system of claim 63, wherein the obligor companies have agreed to preferentially disclose credit information describing themselves to the business entity.

67. A method for performance by a business entity, comprising the steps of:
accepting custody of a majority of a class of financial instruments issued by obligor companies to creditor companies, the business entity also serving as the recorder of the current ownership of the instruments;
operating a market for trading of the instruments by providing computer access to inventory information and order placement facilities.

68. The method of claim 67, further comprising the step of:
extending offers from the business entity to holders of the financial instruments for purchase of the instruments.

69. The method of claim 67, further comprising the step of:
among the business entity and the obligor companies, cooperatively defining terms of financial instruments of the obligor companies.

70. The method of claim 69, wherein the defined terms include the addition of representations and warranties to the financial instruments.

71. The method of claim 69, wherein the defined terms include standardizing terms of financial instruments issued by all members of the group of obligor companies.

72. The method of claim 68, further comprising the step of:
selling in the capital markets securities backed by cash flows from the instruments.

73. The method of claim 67, wherein the obligor companies are a defined group of competing businesses.

74. The method of claim 73, wherein the business entity accepts a majority of a class of financial instruments issued by the obligor companies for storage and recording in a computer system.

75. The method of claim 73, wherein the financing includes offering aggregated baskets of financial instruments issued by two or more of the obligor companies in the capital markets.

76. The method of claim 75, further comprising the step of:
simultaneously assembling at least two baskets of the instruments for securitization to the capital markets as two separate securities.

77. The method of claim 67, further comprising:
in cooperative consultation among the obligor companies, the business entity, and a commercial rating agency, defining terms of the financial instruments.

78. The method of claim 67, wherein:
the obligations are stored as computer records on a computer of the business entity, which records the obligor companies and creditor companies agree to recognize as the sole binding statement of the instruments, without generation of a signed writing evidencing the instruments.

79. A computer system, comprising:
a business-to-business transaction interface comprising circuitry and/or software designed to provide a market for sale of economic inputs from a plurality of seller companies to a plurality of buyer companies; and
a trading interface comprising circuitry and/or software interconnected with the business-to-business transaction interface and designed to provide inventory information and order placement facilities for trading of financial instruments arising out of sales of the economic inputs.

80. The computer system of claim 79, further comprising:
a storage module designed to store book entries of financial instruments issued by obligor companies to obligee companies, the instruments arising out of purchases of the economic inputs sold by the seller companies to the buyer companies, the business-to-business transaction platform being interconnected with the storage module to automatically effect storage of the instruments on closing of the purchases.

81. The computer system of claim 80, wherein:
the seller companies have agreed to accept the book entries as the controlling form of the instruments.
